(19) United States
(12) Patent Application Publication
(10) Pub. No.: US 2013/0224567 A1
(43) Pub. Date: Aug. 29, 2013

(54) HOUSING FOR ACCOMMODATING AT LEAST ONE RECHARGEABLE BATTERY CELL

(71) Applicants: Wolf Matthias, Stuttgart (DE); Thomas Heinrich, Nellmersbach (DE); Josef Baumgartner, Stuttgart (DE)

(72) Inventors: Wolf Matthias, Stuttgart (DE); Thomas Heinrich, Nellmersbach (DE); Josef Baumgartner, Stuttgart (DE)

(21) Appl. No.: 13/820,100

(22) PCT Filed: Jul. 27, 2011
(86) PCT No.: PCT/EP11/62908

§ 371 Date: May 13, 2013

(30) Foreign Application Priority Data
Sep. 1, 2010 (DE) 102010040109.9

(51) Int. Cl. H01M 2/02

(52) U.S. Cl. CPC H01M 2/02
USPC 429/159; 429/178

(57) ABSTRACT

A housing for accommodating at least one rechargeable battery cell, having a terminal region for the electrical contacting of the housing to a device that is operated with an electric motor, in particular to a hand tool, and having at least one connecting line at one side of the at least one rechargeable battery cell, with which the at least one rechargeable battery cell is at least mediately electrically contacted at a pole, the at least one connecting line being guided in particular parallel to the extension of the rechargeable battery cell on the side of the rechargeable battery cell situated opposite the point of connection to the rechargeable battery cell. The housing has a separate cable channel in which the at least one connecting line is guided so as to be spatially separated from the at least one rechargeable battery cell.

### FIELD

The present invention relates to a housing for accommodating at least one rechargeable battery cell.

### BACKGROUND INFORMATION

A housing is described in German Patent Application No. DE 10 2004 043 822 A1. Here, the housing is used in particular to form a so-called battery pack that is capable of being connected to an electric tool, e.g., a cordless screwdriver or similar device. In order to charge the battery pack, the housing is removed from the electric tool and is electrically contacted with a charging station. The rechargeable battery cells situated inside the housing are contacted electrically with one another in a manner corresponding to FIG. 4 of German Patent Application No. DE 10 2004 043 822 A1, for example using cell connectors in the form of stamped metal parts. The cell connectors are connected, by connecting lines, in particular to a terminal region of the housing that creates the electrical contacting to the electric tool or to the charging station. For reasons of spatial economy, and for example for better heat removal, the conventional housing surrounds the rechargeable battery cells with a relatively small gap, or no gap at all. For this reason, the guiding, or routing, of the connecting lines to the terminal region from the cell connectors at the side of the housing situated opposite the terminal region to the terminal region is relatively difficult, and there is the danger that during installation of the connecting lines these may be damaged, so that short-circuits or the like may occur during operation of the battery pack.

### SUMMARY

An object of the present invention is to further develop a housing for accommodating at least one rechargeable battery cell in such a way as to prevent the danger of damage or impairment during operation with a device connected to the housing or in rechargeable battery cells. In accordance with the present invention, the at least one connecting line is guided in a separate cable channel that is spatially separated from the at least one rechargeable battery cell, so that the at least one connecting line cannot come into connection or contact at all with the at least one rechargeable battery cell. In this way, short-circuits or the like between the connecting line and the at least one rechargeable battery cell are reliably prevented.

Advantageous developments of the housing according to the present invention for accommodating at least one rechargeable battery cell are described herein. All combinations of at least two of the features disclosed in the description, and/or the Figures fall within the scope of the present invention.

In order on the one hand to facilitate the guiding through of the at least one connecting line and simultaneously to prevent damage, e.g., in the form of kinks or the like in the connecting line, in an advantageous embodiment of the present invention it is proposed that the cross-section of the cable channel be matched to the cross-section of the at least one connecting line and that it surround the at least one connecting line with a small radial play. Such a solution has in addition the advantage that the space requirement of the housing, viewed overall, is enlarged only to a minimal extent.

It can also be provided that the cable channel is used to guide a plurality of connecting lines. In this way, the outlay for the cable channels is minimized, because only a relatively small number of cable channels is required.

In a concrete embodiment of the present invention that requires a particularly low assembly cost with relatively low manufacturing costs, it is proposed that the housing have a multipart construction and that the cable channel be connected in one piece at least with one of the housing parts, the relevant housing part and the cable channel being fashioned as an injection-molded part.

In a particularly preferred variant, it is provided that the cable channel is fashioned by an intermediate space between a plurality of receptacles that surround the rechargeable battery cells at their circumference.

Alternatively, it is also possible for the housing to have a multipart construction and for the cable channel to be fashioned as a separate component and to be connected to at least one of the housing parts. In this way, the construction of the housing part can be realized relatively simply.

In the last-named variant, it is in addition advantageous that at least one of the housing parts has a receptacle for fastening the cable channel. In this way, a defined guiding of the cable channel in the housing is enabled, and noise due to relative movements between the cable channel and the housing parts is prevented.

Further advantages, features, and details of the present invention result from the following description of preferred exemplary embodiments and on the basis of the figures.

### BRIEF DESCRIPTION OF THE DRAWINGS

FIG. 1 shows a longitudinal section through a housing according to the present invention for accommodating at least one rechargeable battery cell.

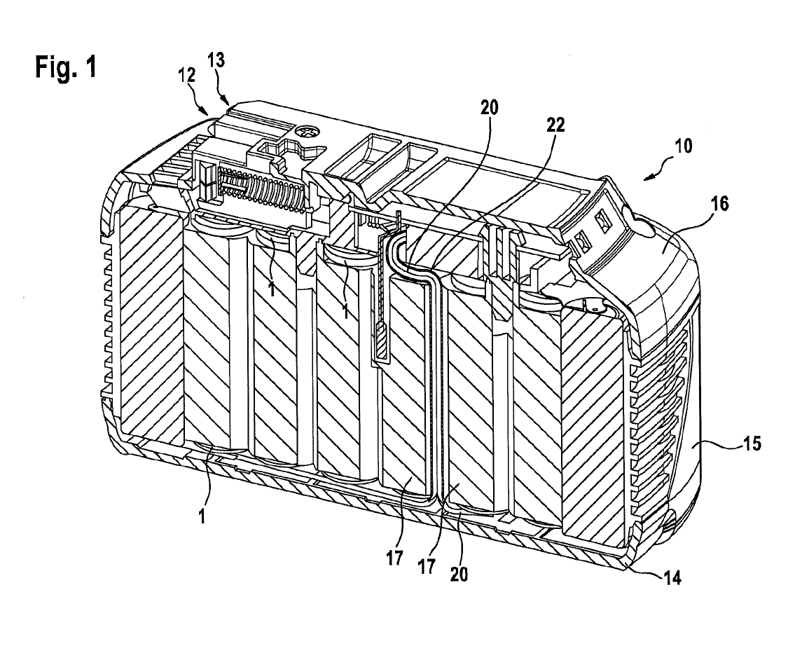

FIG. 2 shows a perspective view of a part of the housing as shown in FIG. 1, without representation of a housing floor.

FIG. 3 shows an exploded view of the housing.

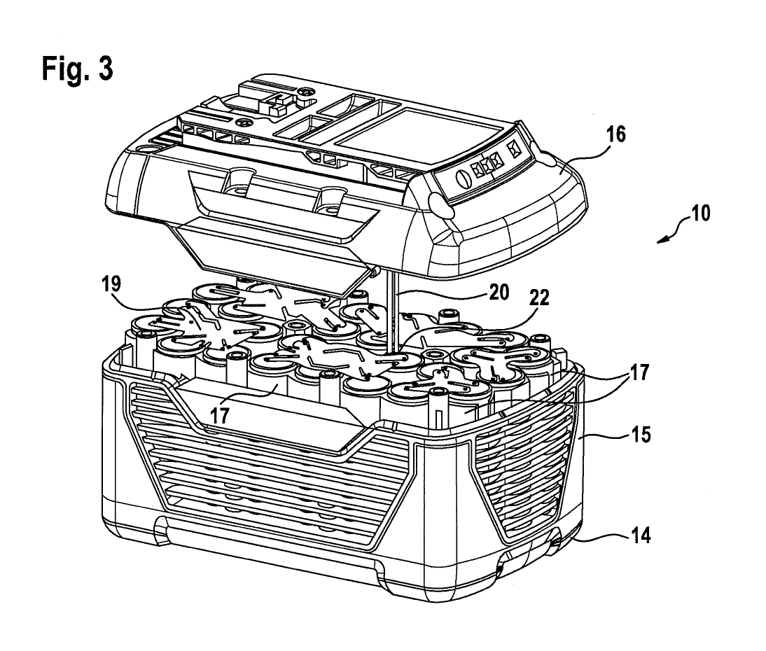

### DETAILED DESCRIPTION OF EXAMPLE EMBODIMENTS

The Figures show a housing 10 according to the present invention for accommodating a plurality of rechargeable battery cells 1. Housing 10 here forms in particular a so-called battery pack that is detachably connected to a device (not shown) that is operated by an electric motor, in particular a hand tool. In order to charge rechargeable battery cells 1 at a charging station (not shown), housing 10 is brought into operative connection with the charging station, while in order to operate the device housing 10 is brought into operative connection with the device. For this purpose, housing 10 has electrical contacts 12, 13, for example situated on the outer side of housing 10, which can be electrically contacted with corresponding counter-contacts of the device or of the charging station.

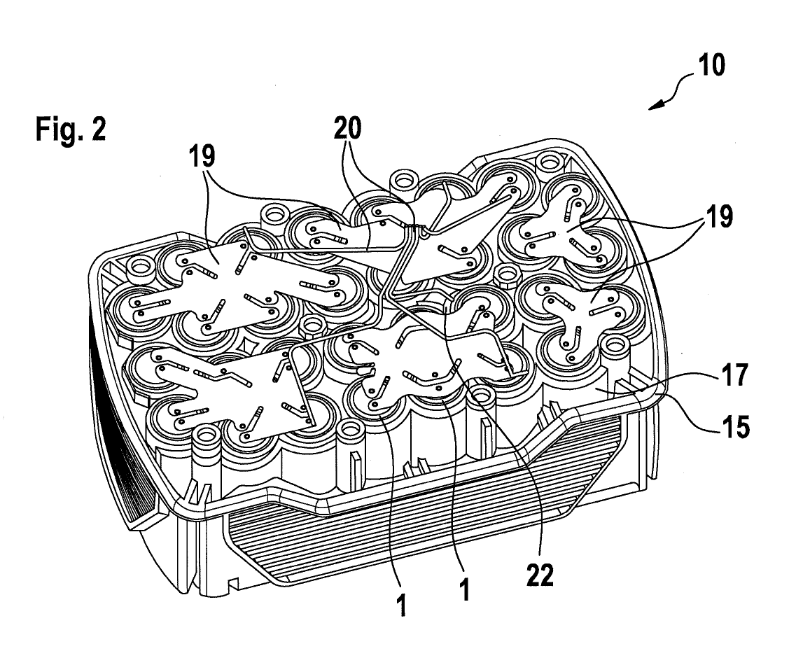

In the depicted exemplary embodiment, housing 10 has a multipart construction, and is made up of a floor part 14, a middle part 15, and a cover part 16. The individual parts are in particular capable of being locked to one another, and if warranted also screwed together and fashioned as injection-molded parts. In addition, in middle part 15 there are situated or fashioned receptacles 17, visible in FIG. 2, for rechargeable battery cells 1, which receptacles surround rechargeable battery cells 1 at their outer circumference at least partially with a positive fit, and accomplish the positioning or fixing of rechargeable battery cells 1 in housing 10. Here, receptacles 17 extend past the outer region of middle part 15, and, when housing 10 is assembled, extend into cover part 16.

In FIG. 2 it can be seen that in each case a determinate number of rechargeable battery cells 1—in the depicted exemplary embodiment, either three rechargeable battery cells 1 or six rechargeable battery cells 1—are electrically connected to one another, in each case by a cell connector 19 fashioned as a stamped metal part. Here, cell connectors 19 are each electrically contacted with the corresponding one pole of rechargeable battery cell 1, e.g., by a spot-welded connection. Cell connectors 19 are situated both in the region of floor part 14 and in the region of cover part 16 of housing 10, and for the connection with electrical contacts 12, 13, which are situated in cover part 16, these cell connectors must be electrically contacted at least mediately to contacts 12, 13 via connecting lines 20, of which only connecting lines 20 in the region of cell connectors 19 of floor part 14 are shown.

Connecting lines 20 are guided along the longitudinal sides of cylindrical rechargeable battery cells 1 from the region of floor part 14, in which the one cell connectors 19 are situated, past the other end face of rechargeable battery cells 1 in the region of cover part 16, to electrical contacts 12, 13. Here, according to the present invention the guiding of connecting lines 20 is made parallel to the longitudinal extension of rechargeable battery cells 1 in intermediate spaces between receptacles 17 for rechargeable battery cells 1 in middle part 15. These intermediate spaces form at least one cable channel 22 for guiding connecting lines 20.

Cable channel or channels 22 are thus integrally formed in one piece on housing 10, or middle part 15 thereof, via the formation of receptacles 17 for rechargeable battery cells 1. It can also be provided to fashion or provide such cable channels 22 at some other location of housing 10, i.e., outside the intermediate spaces between receptacles 17. Here as well, cable channels 22 can be fashioned in one piece on housing 10.

In a further specific embodiment (also not shown), it is also possible for at least one cable channel 22 to be fashioned as a separate component. In this case, it can be provided that the component is connected with or positioned on housing 10 with one of the housing parts, for example via a locking receptacle.

The cross-section of cable channel 22 is dimensioned in such a way that one or more connecting lines 20 inside cable channel 22 are surrounded with a relatively small radial play to the interior of cable channel 22. The length of cable channels 22 is made so as to correspond approximately to the length of rechargeable battery cells 1 in the longitudinal direction thereof. Here, the respective end faces of cable channel 22 are aligned approximately with the respective end faces of rechargeable battery cells 1, or cable channel 22 has a length somewhat shorter than the longitudinal extension of rechargeable battery cells 1.

Housing 10 according to the present invention described in the foregoing for accommodating at least one rechargeable battery cell 1 can be modified in many ways without departing from the idea of the present invention. This idea consists in the disposition or the provision of an additional cable channel 22 for guiding at least one connecting line 20, said channel or channels spatially separating the at least one connecting line 20 from rechargeable battery cell or cells 1, and thus preventing a direct contact of connecting lines 20 with rechargeable battery cells 1.

1-10. (canceled)

11. A housing for accommodating at least one rechargeable battery cell, the housing having a terminal region for electrical contacting of the housing to a device that is operated with an electric motor hand tool, and having at least one connecting line at one side of the at least one rechargeable battery cell, with which the at least one rechargeable battery cell is at least mediately electrically contacted at a pole, the at least one connecting line being guided in parallel to an extension of the rechargeable battery cell at a side of the rechargeable battery cell situated opposite a point of connection to the rechargeable battery cell, wherein the housing has a separate cable channel in which the at least one connecting line is guided so as to be spatially separated from the at least one rechargeable battery cell.

12. The housing as recited in claim 11, wherein a cross-section of the cable channel is matched to a cross-section of the at least one connecting line, and surrounds the at least one connecting line with a small amount of radial play.

13. The housing as recited in claim 11, wherein the cable channel guides a plurality of connecting lines.

14. The housing as recited in claim 11, wherein the housing has a multipart construction, and the cable channel is integrally formed in one piece at least on one of the housing parts, the housing part and the cable channel being fashioned as an injection-molded part.

15. The housing as recited in claim 14, wherein on a housing part there are fashioned receptacles for rechargeable battery cells, and the cable channel is formed by an intermediate space between a plurality of receptacles.

16. The housing as recited in claim 11, wherein the housing has a multipart construction and the cable channel is fashioned as a separate component and is connected to at least one of the housing parts.

17. The housing as recited in claim 16, wherein at least one of the housing parts has a receptacle for fastening the cable channel.

18. The housing as recited in claim 11, wherein a length of the cable channel corresponds approximately to a longitudinal extension of the rechargeable battery cell, and the cable channel terminates with the rechargeable battery cell, approximately at a height of end faces thereof.

19. The housing as recited in claim 11, wherein the housing accommodates a plurality of rechargeable battery cells, each of the cells having a cell connector fashioned as a stamped metal part, and the cell connector is connected to the at least one connecting line.

20. The housing as recited in claim 19, wherein each of the plurality of rechargeable battery cells is connected to a separate cell connector, and at least a plurality of the connecting lines to the cell connectors are guided through a common cable channel.
